(19) United States
(12) Patent Application Publication
(10) Pub. No.: US 2022/0048696 A1
(43) Pub. Date: Feb. 17, 2022

(54) VALVE SEAL AND METERING VALVE FOR FLUID PRODUCT DISPENSER

(71) Applicant: APTAR FRANCE SAS, LE NEUBOURG (FR)

(72) Inventors: Michael BAZIRE, Grand Couronne (FR); Patrice LEONE, Acquigny (FR)

(73) Assignee: APTAR FRANCE SAS, LE NEUBOURG (FR)

(21) Appl. No.: 17/274,913

(22) PCT Filed: Sep. 9, 2019
(86) PCT No.: PCT/FR2019/052062

§ 371 Date: Mar. 10, 2021

(30) Foreign Application Priority Data
Sep. 11, 2018 (FR) 1858131

(51) Int. Cl. B65D 83/54; B65D 83/14

(52) U.S. Cl. CPC B65D 83/54; B05B 11/305; B65D 83/752

(57) ABSTRACT

A valve gasket for a metering valve of a fluid dispenser, said gasket being made of an elastomer material that is self-lubricating.

The present invention relates to a valve gasket, to a metering valve, and to a fluid dispenser.

The preferred field of application of such a valve is the field of pharmacy, but this type of valve may also be used in other fields, e.g. the fields of cosmetics or perfumery.

The metering valves of the prior art comprise a valve body that defines a metering chamber in which a valve member slides between a rest position and an actuated position. The valve body and the valve member are usually made by molding plastics materials of the polymer type, e.g. such as polyacetal (also known as polyoxymethylene (POM)), or polybutylene terephthalate (PBT). Gaskets, in particular an external gasket known as a neck gasket and two internal gaskets known as a valve-member gasket and as a chamber gasket, are generally provided in a metering valve. The gaskets are generally made of elastomer material, e.g. such as nitrile rubber, ethylene propylene diene monomer (EPDM), or cyclo olefin copolymer elastomer (COC elastomer).

The use of such gaskets can pose several problems. Thus, during their manufacture, it is necessary to add talc to the elastomer strips so as to avoid adherence during storage. In addition, in order to assemble the valves, it is necessary to use silicone for packing the gaskets. Furthermore, in use, the friction generated between the valve member and the internal gaskets can lead to the valve jamming, a phenomenon known as “sticking”. In order to attempt to overcome or limit these problems, it has been proposed to use elastomer materials to which lubricants are added, also known as slip agents, generally based on silicone, erucamide, or oleamide. Such additives migrate to the surface of the material, thereby reducing its coefficient of friction and consequently its friction behavior. However, it is not always easy to control such lubrication. Before being able to perform their role of lubricating agents in the elastomer matrix, additives may become degraded while the material is being manufactured. Interactions may also occur with other ingredients present in the elastomer matrix. This occurs in particular in the presence of inorganic fillers, which may absorb the lubricants, thereby preventing them from migrating to the surface of the material.

Documents WO 00/56632 and U.S. Pat No. 6,843,392 describe prior-art devices.

An object of the present invention is to overcome the above-mentioned problems.

An object of the present invention is thus to provide a valve gasket with improved friction properties.

Another object of the present invention is to provide a valve gasket, a metering valve, and a fluid dispenser device that are simple and inexpensive to manufacture and to assemble.

The present invention thus provides a valve gasket for a metering valve of a fluid dispenser, said gasket being made of an elastomer material that is self-lubricating, said elastomer material containing a lubricant, such as silicone oil, said lubricant being encapsulated in the form of microcapsules and/or microspheres that are added to the elastomer material of the gasket.

Advantageously, the elastomer material comprises EPDM.

Advantageously, the lubricant comprises silicone oil.

Advantageously, microcapsules and/or microspheres containing silicone oil are added to the elastomer material while the gasket is being manufactured.

Advantageously, the quantity of said microcapsules and/or microspheres introduced into the elastomer material is less than 5% by weight, advantageously about 3% by weight, of the elastomer material.

The present invention also provides a metering valve of a fluid dispenser, the metering valve comprising a valve body that defines a metering chamber in which a valve member slides between a rest position and an actuated position, said valve including a neck gasket and at least one internal gasket, said valve member sliding against said at least one internal gasket, said metering valve including at least one gasket as described above.

Advantageously, said at least one internal gasket is made as described above.

The present invention also provides a fluid dispenser comprising a reservoir containing fluid to be dispensed, said dispenser including a metering valve as described above.

Advantageously, the dispenser contains a hydrofluoroalkane (HFA) gas as a propellant gas.

These and other characteristics and advantages appear more clearly from the following detailed description, given by way of non-limiting example, and with reference to the accompanying drawings, in which:

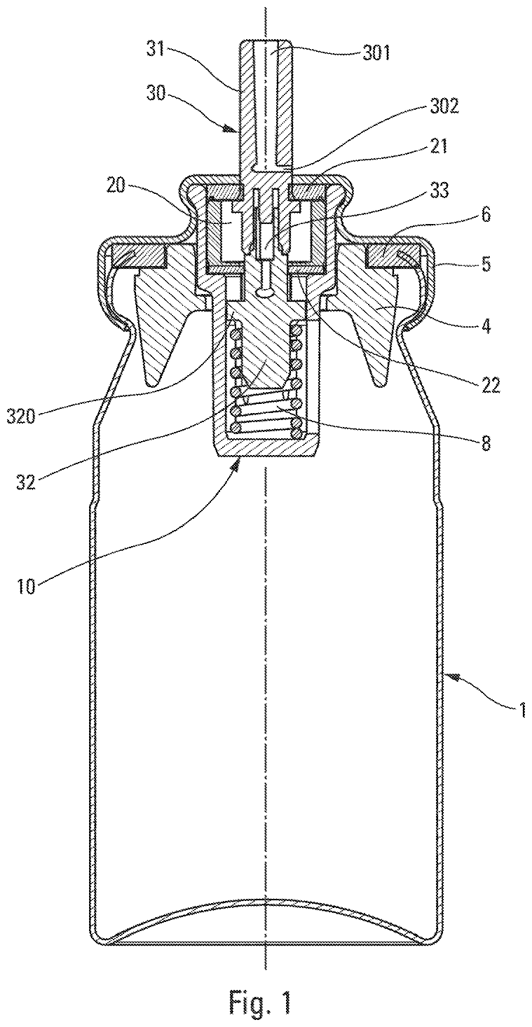

FIG. 1 is a diagrammatic section view of a metering valve in an advantageous embodiment;

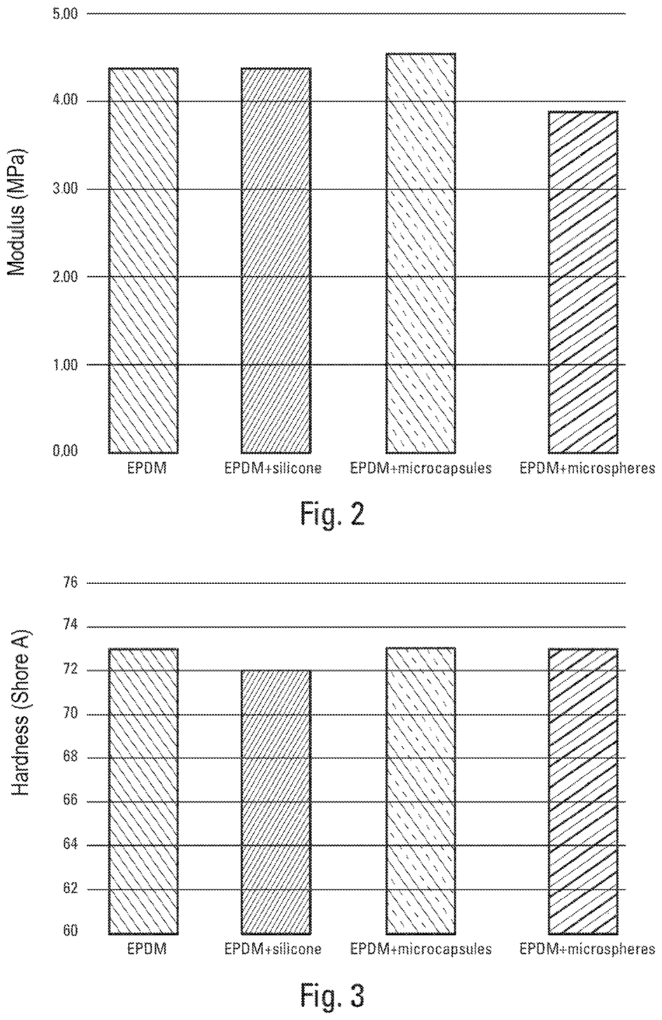

FIG. 2 is a bar chart comparing modulus at 100% deformation of an EPDM gasket, with or without silicone, with an EPDM gasket of the invention containing microcapsules or microspheres;

FIG. 3 is a bar chart comparing hardness on the Shore A scale of an EPDM gasket, with or without silicone, with an EPDM gasket of the invention containing microcapsules or microspheres; and

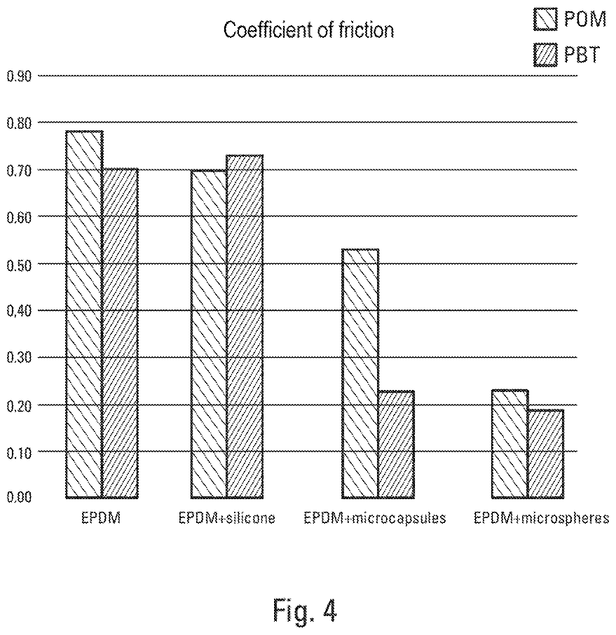

FIG. 4 is a bar chart comparing the coefficient of friction relative to POM and to PBT of an EPDM gasket, with or without silicone, with an EPDM gasket of the invention containing microcapsules or microspheres.

In the description below, the terms “upper” and “lower” and “top” and “bottom” are relative to the upright position shown in FIG. 1, and the term “radial” is relative to the longitudinal axis of the valve shown in FIG. 1.

The metering valve shown in FIG. 1 is of the retention type. However, it should be understood that this is merely an example, and that the present invention applies to any type of metering valve. More generally, the present invention could also apply to gaskets for a pump that does not use propellant gas in order to dispense fluid.

The FIG. 1 valve includes a valve body 10 that extends along a longitudinal axis. Inside said valve body 10, a valve member 30 slides between a rest position, that is the position shown in FIG. 1, and a dispensing position in which the valve member 30 has been pushed into the valve body 10.

The valve is for assembling on a reservoir 1, preferably by means of a fastener element 5 that may be a crimpable, screw-fastenable, or snap-fastenable capsule, and a neck gasket 6 is advantageously interposed between the fastener element and the reservoir. Optionally, a ring 4 may be assembled around the valve body, in particular so as to decrease the dead volume in the upsidedown position, and so as to limit contact between the fluid and the neck gasket. The ring may be of any shape, and the example in FIG. 1 is not limiting.

The valve member 30 is urged towards its rest position by a spring 8 that is arranged in the valve body 10 and that co-operates firstly with the valve body 10 and secondly with the valve member 30, preferably with a radial collar 320 of the valve member 30. A metering chamber 20 is defined inside the valve body 10, said valve member 30 sliding inside said metering chamber so as to enable its contents to be dispensed when the valve is actuated.

In conventional manner, the metering chamber is preferably defined between two annular gaskets, namely a valve-member gasket 21, and a chamber gasket 22.

FIG. 1 shows the valve in the upright storage position, i.e. the position in which the metering chamber 20 is arranged above the reservoir 1.

The valve member 30 includes an outlet orifice 301 that is connected to an inlet orifice 302 that is arranged in the metering chamber 20 when the valve member 30 is in its dispensing position. The valve member 30 may be made of two portions, namely an upper portion 31 (also known as a valve-member top) and a lower portion 32 (also known as a valve-member bottom). In this embodiment, the lower portion 32 is assembled inside the upper portion 31. An internal channel 33 is provided in the valve member 30 that makes it possible to connect the metering chamber 20 to the reservoir 1, so as to fill said metering chamber 20 after each actuation of the valve when the valve member 30 returns to its rest position under the effect of the spring 8. Filling is performed when the device is still in its upsidedown working position, with the valve arranged below the reservoir.

Typically, the metering valve contains a well-known propellant gas, in particular of the HFA type.

In the invention, at least one gasket of the valve, in particular at least one internal gasket 21, 22, is made of an elastomer material that is self-lubricating, a lubricant, such as silicone oil, being encapsulated in the form of microcapsules and/or microspheres that are added to the elastomer material of the gasket. Such microencapsulation makes it possible to control and/or to trigger the lubricating action at clearly defined steps of the manufacturing process and/or while the product is in use.

Microencapsulation makes it possible to hold liquids or solids captive in a polymer membrane in order to protect the outside environment or in order to control their release into a chosen environment. Depending on the preparation technology used and on the final need, it is possible to obtain two types of product:

microcapsules, which may be likened to reservoirs holding captive a liquid active substance (that is more or less viscous); and

microspheres, which are macromolecular matrices that resemble small pouches filled with active substance (like a sponge).

The active principle may be released in several ways. For microcapsules release may be sudden, under the effect of stress such as heat or pressure. Microspheres enable the encapsulated substance to be released progressively. Optionally, it is possible to envisage combining both effects, by adding microcapsules and microspheres simultaneously.

The size of the microcapsules and/or of the microspheres may vary in the range 5 micrometers (μm) to 100 μm.

In the examples described below, microcapsules or microspheres of silicone oil were added at a content of 3% by weight into the EPDM material forming a valve gasket. Adding was performed in the same manner as for the other ingredients (inorganic fillers, antioxidants, vulcanizing agents, etc.) that are usually added into an EPDM material.

Advantageously, a quantity that is less than 5% by weight is envisaged.

The properties of the materials obtained were compared to two controls:

standard EPDM;

standard EPDM +3% of added silicone oil.

FIG. 2 shows modulus at 100% deformation, and FIG. 3 shows hardness on the Shore A scale. It should be observed that adding microcapsules and microspheres does not have a negative impact on the mechanical properties of the elastomer, in this example EPDM.

FIG. 4 shows the coefficient of friction for the same materials, firstly against POM, and secondly against PBT.

The test consisted in rubbing the EPDM against plastics materials (POM & PBT) so as to determine their coefficient of friction.

The coefficient of friction is the ratio of the traction force (response force enabling the apparatus to move) over the applied force (normal force).

Two types of coefficient of friction exist: the coefficient of dynamic friction and the coefficient of static friction.

The static coefficient of friction is the coefficient measured at the beginning of a test. It is the force necessary to move the sample on the substrate and to initiate movement. The term “coefficient of adhesion” is also used;

The dynamic coefficient is the coefficient necessary for movement to be maintained at a constant speed.

For the present comparison, the values of the dynamic coefficient were used, with the system stable and at constant speed.

Merely adding silicone into the formulation gave rise to no improvement for friction. This confirms the assumption that, under such circumstances, the silicone is absorbed by the elastomer matrix.

However, a reduction in the coefficient of friction was observed for all of the configurations of the invention with microcapsules or microspheres.

The results obtained show that adding microcapsules or microspheres makes it possible to reduce the coefficient of friction significantly.

The comparative tests were performed with gaskets made of EPDM, but the same result would be obtained with other elastomer materials used for manufacturing valve gaskets.

Encapsulating the lubricant makes it possible to confine said lubricant so as to avoid it being absorbed or degraded during the process of manufacturing the material. Furthermore, encapsulating the lubricant makes it possible to make the lubricant available at the surface of the material when the microcapsules break under mechanical stress, due to friction or to pressure.

The invention thus makes it possible to reduce problems of friction in valves, and thus to eliminate or at least limit the risks of sticking. Furthermore, adding talc to the elastomer strips so as to avoid adherence during storage is no longer necessary, thereby making it possible to reduce the manufacturing costs of the gaskets and thus of the valve. Assembling the valves is also simplified as a result of reducing or eliminating the use of silicone for packaging the gaskets.

The present invention is described above with reference to an advantageous embodiment, but naturally any modification could be applied thereto by the person skilled in the art, without going beyond the ambit of the present invention, as defined by the accompanying claims.

1. A valve gasket for a metering valve of a fluid dispenser, wherein said gasket is made of an elastomer material that is self-lubricating, said elastomer material containing a lubricant, such as silicone oil, said lubricant being encapsulated in the form of microcapsules and/or microspheres that are added to the elastomer material of the gasket.

2. A gasket according to claim 1, wherein the elastomer material comprises EPDM.

3. A gasket according to claim 1, wherein the lubricant comprises silicone oil.

4. A gasket according to claim 1, wherein microcapsules and/or microspheres containing silicone oil are added to the elastomer material while the gasket is being manufactured.

5. A gasket according to claim 4, wherein the quantity of said microcapsules and/or microspheres introduced into the elastomer material is less than 5% by weight, advantageously about 3% by weight, of the elastomer material.

6. A metering valve of a fluid dispenser, the metering valve comprising a valve body that defines a metering chamber in which a valve member slides between a rest position and an actuated position, said valve including a neck gasket and at least one internal gasket, said valve member sliding against said at least internal gasket, wherein one of said neck gasket or said at least one internal gasket is according to claim 1.

7. A valve according to claim 6, wherein said one of said neck gasket or said at least one internal gasket is said at least one internal gasket.

8. A fluid dispenser comprising a reservoir containing fluid to be dispensed, said dispenser comprising a metering valve according to claim 6.

9. A dispenser according to claim 8, containing a HFA gas as a propellant gas.
